(19) United States
(12) Patent Application Publication
(10) Pub. No.: US 2024/0270974 A1
(43) Pub. Date: Aug. 15, 2024

(54) WATER-REPELLENT MATERIAL, WATER-REPELLENT PAINT, METHOD FOR PRODUCING WATER-REPELLENT CONCRETE, METHOD FOR PREVENTING GENERATION OF MOLD, AND METHOD FOR PREVENTING RUSTING

(71) Applicants: Kazumi TOUSHIN, Okayama (JP); Akemi Hayashi, Okayama (JP); Earth Energy Co., Ltd. Seisin, Okayama (JP)

(72) Inventor: Kazumi Toushin, Okayama (JP)

(21) Appl. No.: 18/480,731

(22) Filed: Oct. 4, 2023

(30) Foreign Application Priority Data
Feb. 10, 2023 (JP) 2023-019011

(51) Int. Cl. C09C 1/44; C04B 18/02; C04B 18/10; C09C 3/04; C09D 5/08; C09D 5/16; C09D 7/61

(52) U.S. Cl. CPC C09C 1/44; C04B 18/022; C04B 18/101; C09C 3/043; C09D 5/084; C09D 5/1618; C09D 7/61; C04B 2103/65

(57) ABSTRACT

Present disclosure aims at providing a water-repellent material using waste rice husks, a method for producing the water-repellent material, a method for producing water-repellent paint containing the water-repellent material, a method for producing water-repellent concrete containing the water-repellent material, a method for preventing generation of mold using the water-repellent material, and a method for preventing rusting using the water-repellent material. The present disclosure provides, a method for producing a water-repellent material, and others, including: mixing burned rice husks and silicone oil; and burning a mixture of the rice husks with silicon oil to obtain a water-repellent burned product.

### FIELD

The present invention relates to a method for producing water-repellent material, a method for producing water-repellent paint, a method for producing water-repellent concrete, a method for preventing generation of mold, and a method for preventing rusting.

### BACKGROUND

A liquid water-repellent material that contains silicone oil has been known, as described in Patent Literature 1. The water-repellent material described in Patent Literature 1 is considered to be a liquid water-repellent composition containing paraffinic oil or low-molecular weight hydrocarbon resin, these having 0.4 or less of a separation index to silicone oil and silicone oil.

### CITATION LIST

### Patent Literature

Patent Literature 1: Japanese Patent Application Laid-open No. S61-115988

### SUMMARY

### Technical Problem

In the case of Patent Literature 1 in which the water-repellent material mainly composed of purified compounds is used, production of raw materials for the water-repellent composition is costly, so that the cost of the water-repellent composition tends to increase. The use of a waste material as a raw material for the water-repellent material could reduce the production cost of the water-repellent material, but there is no such disclosure in the cited reference 1.

An object of the present invention is to provide water-repellent material using waste rice husks, a method for producing the water-repellent material, a method for producing water-repellent paint containing the water-repellent material, a method for producing water-repellent concrete containing the water-repellent material, a method for preventing generation of mold using the water-repellent material, and a method for preventing rusting using the water-repellent material.

### Solution to Problem

The problem described above can be solved by a method for producing water-repellent material, including: mixing burned rice husks and silicone oil; and burning a mixture of the rice husks with the silicone oil to obtain a water-repellent burned product.

The problem described above can be solved by a method for producing water-repellent material, including: burning rice husks; mixing the burned rice husks and silicone oil; and burning a mixture of the rice husks with the silicone oil to obtain a water-repellent burned product.

The problem described above can be solved by a method for producing water-repellent paint, including mixing the water-repellent material mentioned above and paint.

The problem described above can be solved by a method for producing water-repellent concrete, including mixing the water-repellent material and a concrete composition.

The problem described above can be solved by a method for preventing generation of mold, including applying the water-repellent paint mentioned above onto a structure to prevent generation of mold in the structure.

The problem described above can be solved by a method for preventing rusting, comprising applying the water-repellent paint onto a metal material to prevent rusting.

The problem described above can be solved by a water-repellent material including: burned rice husks; and silicone oil.

In the method for producing the water-repellent material, the temperature at the time of burning the mixture may be 500 to 900° C. In the method for producing the water-repellent paint, an amount of the water-repellent material may be 0.5 to 6% by mass of the paint in terms of the mass of the paint before blending with the water-repellent material. In the method for producing the water-repellent concrete, an amount of the water-repellent material may be 0.5 to 6% by mass of cement in terms of the mass of the cement that is blended with the concrete composition.

### Effects of Invention

According to the present disclosure, provided are water-repellent material using waste rice husks, a method for producing the water-repellent material, a method for producing water-repellent paint containing the water-repellent material, a method for producing water-repellent concrete containing the water-repellent material, a method for preventing generation of mold using the water-repellent material, and a method for preventing rusting using the water-repellent material.

### DESCRIPTION OF EMBODIMENTS

Hereinafter, a preferred embodiment of the present disclosure will be described. The embodiments described below are only limited examples of embodiment of the present disclosure, so that the technical scope of the present invention is not limited to the embodiments illustrated by Examples.

The method for producing the water-repellent material according to this embodiment including: burning rice husks; mixing the burned rice husks and silicone oil; and burning a mixture of the rice husks with the silicone oil to obtain a water-repellent burned product.

The rice husk is the outer husk of unhulled rice. From a cost perspective, the rice husks, which are discharged as the industrial waste at the time when the rice husks are removed from rice, can be suitably used. A rice plant is a silicicolous plant that actively absorbs silicic acid from the soil. The absorbed silicic accumulates in high concentration in the rice husk.

In the process at which the rice husks are burned, the rice husks may be burned by an appropriate method. When burning the rice husks, it is preferable to heat the rice husks to the degree where the rice husks turn black in color under the condition where oxygen is supplied and complete combustion can take place. The temperature at the time of burning the rice husks is preferably, for example, 500 to 900° C. Burning of the rice husks yields a black burned product with a high silica (SiO₂) content. The silica content in the black burned product is, for example, 90 to 98% by mass. In addition, the burning of the rice husks makes them porous. Silica has excellent resistances to chemicals and heat, and is less likely to degenerate. Therefore, the material having been mixed with silicone oil followed by burning is not easily affected by an acid rain, chemicals, and the like, so that this becomes a durable water-repellent material. By having the silicone oil supported on the burned rice husks, which are mainly composed of highly durable silica, the silicone oil itself also becomes less likely to decompose or degenerate, so that the water-repellent effect thereof can sustain for a long period of time.

At the process of mixing the burned rice husks with the silicone oil, it is preferable that the silicone oil be mixed at a ratio of 4 to 200 parts by mass of the silicone oil to 100 parts by mass of the burned rice husks. The silicone oil is more preferably 4 to 50 parts by mass, and even more preferably 4 to 15 parts by mass. At this process, the silicone oil is supported on the rice husks. The burned rice husks mainly composed of silica have well compatibility with silicone oil and thus can be uniformly blended with silicone oil at the time of mixing.

A commercially available silicone oil having a water contact angle of 40 degrees or more according to the static dropping method in JISR3257:1999 may be suitably used. The contact angle is more preferably 90 degrees or more. The upper limit of the contact angle is not particularly restricted, but this is, for example, 160 degrees or less, 150 degrees or less, and the like. Examples of the silicone oil include, as an active ingredient in it, a polymer having a siloxane bond in its main chain.

At the process of burning the mixture of the rice husks with the silicone oil to obtain the water-repellent burned product, the mixture of the burned rice husks with the silicone oil is burned. When burning the rice husks, it is preferable to heat the rice husks to the degree where the rice husks turn white in color under the condition where oxygen is supplied and complete combustion can take place. The temperature at the time of burning the rice husks is preferably, for example, 500 to 900° C.

The white burned product obtained by the above method has water repellency. For example, when the white burned product is blended with a concrete composition, a water-repellent concrete molded article can be obtained. When the white burned product is blended with paint, a water-repellent paint can be obtained.

The water-repellent concrete molded article exerts water-repellent itself. Therefore, when a structure that is installed outdoors such as an exterior wall is constructed using the concrete molded article, penetration of water into the concrete molded article can be prevented, so that generation of mold in this structure can be effectively prevented. When the concrete molded article has reinforcing iron bars, corrosion of the iron bars can be effectively prevented. Examples of the structure include an exterior wall, a staircase, a flower bed, a gate post, a ramp, an interior wall of tunnel, and a pedestal.

The composition of the concrete composition is not particularly restricted as long as it includes cement, aggregate, and water. A surfactant may be blended in order to facilitate mixing of the water-repellent material with the composition. The amount of water-repellent material in the concrete composition is preferably 0.5 to 6% by mass in terms of the mass of the cement that is blended with a cement composition. The concrete composition may be blended with a surfactant.

When the water-repellent paint is applied to the surface of a structure installed outdoors, this will prevent water from penetrating into the structure, resulting in effective prevention of generation of mold in the structure. In addition, when the water-repellent paint is applied to the ship's bottom, barnacles, algae, and the like can be effectively prevented from attaching to the ship's bottom.

When the water-repellent paint is applied to the surface of a metal material, the metal material can be prevented from rusting. Examples of the metal material include fence and playground equipment, which are products composed of a metal and are corrosive.

There is no particular restriction in the paint; the water-repellent material may be blended with any of oil-based paint and water-based paint. The amount of the water-repellent material to be blended with the paint is preferably 0.5 to 6% by mass of the paint in terms of the mass of the paint before blending with the water-repellent material. The paint is preferably those containing a synthetic resin component that is cured when solvent is vaporized. The paint may be blended with a surfactant.

### EXAMPLES

Hereinafter, the disclosure will be described more specifically with reference to Examples. Examples described below are mere limited examples, so that the technical scope of the present invention should not be limited to the examples described below.

### Example 1

Ears of rice was threshed; then, the dried unhulled rice was hulled using a huller. By hulling, 50 kg of rice husks were obtained. The rice husks (50 kg) were burned in a rotary kiln with the condition of supplying oxygen at 700° C. for 1 hour to obtain 1 kg of a black burned product.

The burned product (1 kg) was mixed with 100 g of a commercially available silicone oil (KF-99, manufactured by Shin-Etsu Chemical Co. Ltd.). The mixture was then burned in a rotary kiln at 700ºC for 1 hour to obtain a white burned water-repellent material. The form of this water-repellent material is powdery granules.

When the water-repellent material obtained in Example 1 was placed in a container and then a few milliliters of water was dropped onto the material, the water droplet on the powdery water-repellent material turned into like a ball, and thereby it was confirmed that the water-repellent material exerts the water-repellent effect.

### Example 2

By mixing 100 g of cement, 875 g of sand, and 25 g of water, 1 kg of a concrete composition was obtained. The resulting concrete composition was mixed with 25 g of the water-repellent material obtained by the method of Example 1 and 6 g of surfactant.

This mixture was cast into a mold and cured for 30 days to obtain a concrete block relating to Example 2.

### Comparative Example 1

The concrete block was produced in the same manner as in Example 2, except that in the concrete composition, 25 g of the before-mentioned commercially available silicone oil was blended in place of the water-repellent material obtained by the method of Example 1.

### [Water Penetration Test]

These concrete blocks were immersed in a sufficient amount of water and left for one week. After one week, the concrete blocks were pulled up, and then they were broken to visually check whether or not penetration of water into the concrete blocks occurred.

It was confirmed that water did not penetrate into the concrete block produced by the method of Example 2.

In the concrete block obtained in Comparative Example 1, which was prepared for comparison, water penetrated slightly into the concrete having been immersed in water for one week. The trend was recognized that the longer this concrete block was immersed in water, the greater the degree of penetration of water was. From this, it was confirmed that when the silicone oil is blended, the water-repellent performance thereof tends to be difficult to sustain over a long period of time.

### [Generation of Mold]

The concrete block obtained in Example 2 was left in the shade outdoors and visually checked whether or not mold grows. In the concrete block obtained in Example 2, the water did not penetrate into the concrete block due to the strong water-repellent effect, so that there was no mold generated.

In the concrete block obtained in Comparative Example 1, which was prepared for comparison, it was confirmed that a small amount of water had penetrated into the concrete block and mold was slightly generated. The trend was confirmed that the longer the concrete block was left outdoors, the greater the degree of mold growth was. From this, it was confirmed that when the silicone oil is blended, the anti-molding performance tends to be difficult to sustain over a long period of time.

### Example 3

Into 4 liters of a commercially available oil-based paint, 150 g of the water-repellent material obtained by the method of Example 1 was added, and then, the resulting mixture was stirred well to obtain paint.

### Comparative Example 2

Paint was obtained in the same way as in Example 3, except that 150 g of the same silicone oil was used in place of the water-repellent material.

### [Generation of Mold]

The paint obtained in Example 3 was applied to a commercially available concrete block using a brush. The concrete block was left in the shade outdoors and visually checked whether or not mold grows. In the concrete block coated with the paint obtained in Example 3, the water did not penetrate into the concrete block due to the strong water-repellent effect, so that there was no mold generated.

In the concrete block coated with the paint obtained in Comparative Example 2, which was prepared for comparison, it was confirmed that a small amount of water had penetrated into the concrete block and mold was slightly generated. The trend was confirmed that the longer the concrete block was allowed to stand outdoors, the greater the degree of generation of mold was. From this, it was confirmed that when the silicone oil is blended, the anti-molding performance tends to be difficult to sustain over a long period of time.

1. A method for producing a water-repellent material, comprising:
mixing burned rice husks and silicone oil; and
burning a mixture of the rice husks with the silicon oil to obtain a water-repellent burned product.

2. A method for producing a water-repellent material, comprising:
burning rice husks;
mixing the burned rice husks and silicone oil; and
burning a mixture of the rice husks with the silicon oil to obtain a water-repellent burned product.

3. The method for producing the water-repellent material according to claim 1, wherein a temperature for burning the mixture is 500 to 900° C.

4. A method for producing water-repellent paint, comprising mixing the water-repellent material according to claim 1 with paint.

5. The method for producing the water-repellent paint according to claim 4, wherein an amount of the water-repellent material is 0.5 to 6% by mass of the paint in terms of mass of the paint before blending with the water-repellent material.

6. A method for producing water-repellent concrete, comprising mixing the water-repellent material according to claim 1 with a concrete composition.

7. The method for producing the water-repellent concrete according to claim 6, wherein an amount of the water-repellent material is 0.5 to 6% by mass in terms of the concrete composition before blending with the water repellent material.

8. A method for preventing generation of mold, comprising applying the water-repellent paint according to claim 4 onto a structure to prevent generation of mold in the structure.

9. A method for preventing rusting comprising applying the water-repellent paint according to claim 4 onto a metal material to prevent rusting.

10. A water-repellent material comprising: burned rice husks; and silicone oil.
